(19) United States
(12) Patent Application Publication
(10) Pub. No.: US 2025/0291269 A1
(43) Pub. Date: Sep. 18, 2025

(54) ELECTROSTATIC IMAGE DEVELOPING TONER, ELECTROSTATIC IMAGE DEVELOPER, TONER CARTRIDGE, PROCESS CARTRIDGE, IMAGE FORMING APPARATUS, AND IMAGE FORMING METHOD

(71) Applicant: FUJIFILM BUSINESS INNOVATION CORP., Tokyo (JP)

(72) Inventors: Misaki HORIUCHI, Kanagawa (JP); Kohei MANABE, Kanagawa (JP); Yukiaki NAKAMURA, Kanagawa (JP)

(73) Assignee: FUJIFILM BUSINESS INNOVATION CORP., Tokyo (JP)

(21) Appl. No.: 18/769,961

(22) Filed: Jul. 11, 2024

(30) Foreign Application Priority Data
Mar. 14, 2024 (JP) 2024-039970

(51) Int. Cl. G03G 9/093; G03G 15/01; G03G 21/18

(52) U.S. Cl. CPC G03G 9/09378; G03G 15/0126; G03G 21/1814

(57) ABSTRACT

A core-shell electrostatic image developing toner includes toner particles including a binder resin and a fluorescent colorant. The toner particles have a structure including a core and a shell layer. The core includes the fluorescent colorant. The shell layer includes an ultraviolet absorber and at least one selected from the group consisting of a radical scavenger and a peroxide decomposer.

### CROSS-REFERENCE TO RELATED APPLICATIONS

This application is based on and claims priority under 35 USC 119 from Japanese Patent Application No. 2024-039970 filed Mar. 14, 2024.

### BACKGROUND

### (i) Technical Field

The present disclosure relates to an electrostatic image developing toner, an electrostatic image developer, a toner cartridge, a process cartridge, an image forming apparatus, and an image forming method.

### (ii) Related Art

Japanese Unexamined Patent Application Publication No. 1995-20653 (H7-20653) discloses an electrophotographic magenta toner that includes an oil-soluble dye “C.I. Solvent Red 49” that serves as a colorant, the electrophotographic toner further including an antioxidant and a nickel complex compound as essential components.

Japanese Unexamined Patent Application Publication No. 2007-133093 discloses an electrostatic latent image developing toner that has a core layer including a first binder resin and a colorant and a shell layer that includes a second binder resin and covers the core layer, the shell layer further including at least an ultraviolet inhibitor.

Japanese Unexamined Patent Application Publication No. 1989-172976 (H1-172976) discloses a toner production method including a first step of mixing an ultraviolet absorber and/or an antioxidant with a dye and/or a pigment and a second step of mixing the mixture prepared in the first step with a binder resin.

Japanese Unexamined Patent Application Publication No. 2017-3818 discloses a toner including a binder resin and a colorant, the colorant including a coloring pigment and a fluorescent dye. Furthermore, when the contents of the coloring pigment and the fluorescent dye in the toner on a mass basis are defined as W_{G} and W_{F}, respectively, W_{G} and W_{F} satisfy Formula (1) below.

$${W}_{G} \times 0.5 > {W}_{F} > {W}_{G} \times 0.025 \qquad ( 1 )$$

Moreover, when the absorption peak wavelength of the coloring pigment is defined as P_{G} and the emission peak wavelength of the fluorescent dye is defined as P_{F}, P_{G} and P_{F} satisfy Formula (2) below.

$${P}_{G} < {P}_{F} \qquad ( 2 )$$

Japanese Unexamined Patent Application Publication No. 2010-107617 discloses an electrostatic image developing toner including toner particles including a binder resin, a colorant, and an ultraviolet absorber, the toner particles being each constituted by a core layer including at least a binder resin and a colorant, a shell layer arranged to cover the core layer, and an intermediate layer interposed therebetween, the intermediate layer including the ultraviolet absorber.

### SUMMARY

Aspects of non-limiting embodiments of the present disclosure relate to an electrostatic image developing toner highly resistant to fading caused by ultraviolet radiation, compared with a core-shell electrostatic image developing toner including toner particles including a binder resin and a fluorescent colorant, wherein the shell layer does not include an ultraviolet absorber or at least one selected from the group consisting of a radical scavenger and a peroxide decomposer.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a core-shell electrostatic image developing toner including toner particles including a binder resin and a fluorescent colorant, the toner particles having a structure including a core and a shell layer, the core including the fluorescent colorant, the shell layer including an ultraviolet absorber and at least one selected from the group consisting of a radical scavenger and a peroxide decomposer.

### BRIEF DESCRIPTION OF THE DRAWINGS

Exemplary embodiments of the present disclosure will be described in detail based on the following figures, wherein:

FIG. 1 is a schematic diagram illustrating an image forming apparatus according to an exemplary embodiment; and

FIG. 2 is a schematic diagram illustrating a process cartridge according to an exemplary embodiment.

FIG. 3 shows examples of the spectra of various fluorescent colors.

### DETAILED DESCRIPTION

Exemplary embodiments of the present disclosure are described below. It should be noted that the following description and Examples are illustrative of the exemplary embodiments but not restrictive of the scope of the exemplary embodiments.

In the present disclosure, a numerical range expressed using “to” means the range that includes the values described before and after “to” as the minimum and maximum values, respectively.

In the present disclosure, when numerical ranges are described in a stepwise manner, the upper or lower limit of a numerical range may be replaced with the upper or lower limit of another numerical range, respectively. In the present disclosure, the upper or lower limit of a numerical range may also be replaced with a value described in Examples below.

In the present disclosure, the term “step” refers not only to an individual step but also to a step that is not distinguishable from other steps but achieves the intended purpose of the step.

In the present disclosure, when an exemplary embodiment is described with reference to a drawing, the structure of the exemplary embodiment is not limited to the structure illustrated in the drawing. The sizes of the members illustrated in the attached drawing are conceptual and do not limit the relative relationship among the sizes of the members.

Each of the components described in the present disclosure may include a plurality of types of substances that correspond to the component. In the present disclosure, in the case where a composition includes a plurality of substances that correspond to a component of the composition, the content of the component in the composition is the total content of the substances in the composition unless otherwise specified.

Each of the components described in the present disclosure may include a plurality of types of particles that correspond to the component. In the case where a composition includes a plurality of particles that correspond to a component of the composition, the size of particles of the component is the size of particles of a mixture of the plurality of particles included in the composition unless otherwise specified.

In the present disclosure, the term “(meth) acryl” refers to both “acryl” and “methacryl”, and the term “(meth)acrylate” refers to both “acrylate” and “methacrylate”.

In the present disclosure, “electrostatic image developing toner”, “electrostatic image developer”, and “electrostatic image developing carrier” are also referred to as “toner”, “developer”, and “carrier”, respectively.

### Electrostatic Image Developing Toner

An electrostatic image developing toner according to an exemplary embodiment is a core-shell electrostatic image developing toner that includes toner particles including a binder resin and a fluorescent colorant, the toner particles having a structure including a core and a shell layer, the core including the fluorescent colorant, the shell layer including an ultraviolet absorber and at least one selected from the group consisting of a radical scavenger and a peroxide decomposer.

The electrostatic image developing toners known in the related art are likely to cause color fading when, for example, a sunlight- or ultraviolet-cure varnish (UV varnish) is cured, as a result of a fluorescent colorant being decomposed by ultraviolet radiation to produce radicals and activated oxygen, which cause further decomposition of the fluorescent colorant.

Since the electrostatic image developing toner according to this exemplary embodiment is a core-shell electrostatic image developing toner that includes a core including the fluorescent colorant and a shell layer including an ultraviolet absorber and at least one selected from the group consisting of a radical scavenger and a peroxide decomposer, the decomposition of the fluorescent colorant by the radicals or activated oxygen may be limited. In addition, the radical scavenger or the peroxide decomposer may enhance the dispersibility of the ultraviolet absorber, which results in further high ultraviolet absorptivity. Consequently, the electrostatic image developing toner according to this exemplary embodiment may be highly resistant to fading caused by ultraviolet radiation.

The electrostatic image developing toner according to this exemplary embodiment may also have a high color forming property.

Details of the structure of the electrostatic image developing toner according to this exemplary embodiment are described below.

### Toner Particles

The electrostatic image developing toner according to this exemplary embodiment is a core-shell electrostatic image developing toner that includes toner particles including a binder resin and a fluorescent colorant. The core includes a binder resin and the fluorescent colorant. The shell layer includes a binder resin, an ultraviolet absorber, and at least one selected from the group consisting of a radical scavenger and a peroxide decomposer. The core and the shell layer may include a release agent and additives as needed.

### Ultraviolet Absorber

The shell layer of the toner particles includes an ultraviolet absorber.

Examples of the ultraviolet absorber include a benzophenone compound, a benzotriazole compound, a triazine compound, a salicylic acid compound, and an oxamide compound.

The triazine compound may be any compound having a triazine structure. Examples of the triazine compound include 2-(4-butoxy-2-hydroxyphenyl)-4,6-bis(4-butoxyphenyl)-1,3,5-triazine, 2-(4-butoxy-2-hydroxyphenyl)-4,6-bis(2,4-dibutoxyphenyl)-1,3,5-triazine, 2,4-bis(4-butoxy-2-hydroxyphenyl)-6-(4-butoxyphenyl)-1,3,5-triazine, 2,4-bis(4-butoxy-2-hydroxyphenyl)-6-(2,4-dibutoxyphenyl)-1,3,5-triazine, 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxypropoxy)phenyl]-4,6-bis(2,4-dimethyl)-1,3,5-triazine, 2-[2-hydroxy-4-(2-hydroxy-3-octyloxypropyloxy)phenyl]-4,6-bis(2,4-dimethyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[2-hydroxy-4-(2-hydroxy-3-dodecyloxypropoxy)phenyl]-4,6-bis(2,4-dimethylphenyl)-1,3,5-triazine, 2-(2-hydroxy-4-hexyloxy)phenyl-4,6-diphenyl-1,3,5-triazine, 2-(2-hydroxy-4-methoxyphenyl)-4,6-diphenyl-1,3,5-triazine, 2,4,6-tris(2-hydroxy-4-(3-butoxy-2-hydroxypropoxy)phenyl)-1,3,5-triazine, 2-(2-hydroxyphenyl)-4-(4-methoxyphenyl)-6-phenyl-1,3,5-triazine, 2-{2-hydroxy-4-[3-(2-ethylhexyl-1-oxy)-2-hydroxy-propyloxy]phenyl}-4,6-bis(2,4-dimethylphenyl)-1,3,5-triazine, and 2-(2-hydroxy-4-(2-ethylhexyl)oxy)phenyl-4,6-bis(4-phenyl)phenyl-1,3,5-triazine.

The benzotriazole compound may be any compound having a benzotriazole structure. Examples of the benzotriazole compound include 2-(2′-hydroxy-5′-methylphenyl)benzotriazole, 2-(2′-hydroxy-5′-t-butylphenyl)benzotriazole, 2-(2′-hydroxy-3′-t-butyl-5′-methylphenyl)-5-chlorobenzotriazole, 2-(2′-hydroxy-3′,5′-di-t-butylphenyl)-5-chlorobenzotriazole, 2-(2′-hydroxy-3′-dodecyl-5′-methylphenyl)-5-chlorobenzotriazole, 2-(2′-hydroxy-3′,5′-di-t-amylphenyl)benzotriazole, 2-(2′-hydroxy-5′-(1,1,3,3-tetramethylbutyl)phenyl)benzotriazole, 2-(2′-hydroxy-4′-octyloxyphenyl)benzotriazole, 2-(2′-hydroxy-3′-(3,4,5,6-tetrahydrophthalimidylmethyl)-5′-methylbenzyl)phenyl)benzotriazole, 2-(3′-sec-butyl-5′-t-butyl-2′-hydroxyphenyl)benzotriazole, 2-(3′,5′-bis-(α,α-dimethylbenzyl)-2′-hydroxyphenyl)benzotriazole, 2-(3′-t-butyl-2′-hydroxy-5′-(2-octyloxycarbonylethyl)phenyl)-5-chloro-benzotriazole, 2-(3′-t-butyl-5′-[2-(2-ethylhexyloxy)-carbonylethyl]-2′-hydroxyphenyl)-5-chloro-benzotriazole, 2-(3′-t-butyl-2′-hydroxy-5′-(2-methoxycarbonylethyl)phenyl)-5-chloro-benzotriazole, 2-(3′-t-butyl-2′-hydroxy-5′-(2-methoxycarbonylethyl)phenyl)benzotriazole, 2-(3′-t-butyl-2′-hydroxy-5′-(2-octyloxycarbonylethyl)phenyl)benzotriazole, 2-(3′-t-butyl-5′-[2-(2-ethylhexyloxy)carbonylethyl]-2′-hydroxyphenyl)benzotriazole, 2-(3′-dodecyl-2′-hydroxy-5′-methylphenyl)benzotriazole, 2-(3′-t-butyl-2′-hydroxy-5′-(2-isooctyloxycarbonylethyl)phenylbenzotriazole, and 2,2′-methylene-bis[4-(1,1,3,3-tetramethylbutyl)-6-benzotriazol-2-ylphenol].

The benzophenone compound may be any compound having a benzophenone structure. Examples of the benzophenone compound include 2,4-dihydroxybenzophenone, 2-hydroxy-4-methoxybenzophenone, 2-hydroxy-4-octyloxybenzophenone, 2-hydroxy-4-decyloxybenzophenone, 2-hydroxy-4-dodecyloxybenzophenone, 2-hydroxy-4-benzyloxybenzophenone, 2-hydroxy-4-(2-hydroxy-3-methacryloxypropoxy)benzophenone, 2-hydroxy-4-methoxy-5-sulfobenzophenone, 2-hydroxy-4-methoxy-5-sulfobenzophenone trihydrate, 2-hydroxy-4-methoxy-2′-carboxybenzophenone, 2-hydroxy-4-octadecyloxybenzophenone, 2-hydroxy-4-diethylamino-2′-hexyloxycarbonylbenzophenone, 2,2′-dihydroxy-4-methoxybenzophenone, 2,2′,4,4′-tetrahydroxybenzophenone, 2,2′-dihydroxy-4,4′-dimethoxybenzophenone, and 1,4-bis(4-benzyloxy-3-hydroxyphenoxy)butane.

The salicylic acid compound may be any compound having a salicylic acid structure. Examples of the salicylic acid compound include phenyl salicylate, 4-t-butylphenyl salicylate, 4-octylphenyl salicylate, dibenzoyl resorcinol, bis(4-t-butylbenzoyl) resorcinol, benzoyl resorcinol, 2,4-di-t-butylphenyl 3,5-di-t-butyl-4-hydroxysalicylate, and hexadecyl 3,5-di-t-butyl-4-hydroxysalicylate.

Among these, the triazine compound may be used as an ultraviolet absorber in consideration of resistance to fading caused by ultraviolet radiation.

The above ultraviolet absorbers may be used alone or in combination of two or more.

The content of the ultraviolet absorber is preferably 0.01% by mass or more and 10% by mass or less, is more preferably 0.02% by mass or more and 5% by mass or less, is further preferably 0.1% by mass or more and 2.0% by mass or less, and is particularly preferably 0.2% by mass or more and 1.5% by mass or less of the total mass of the toner particles in consideration of a color forming property and resistance to fading caused by ultraviolet radiation.

### Radical Scavenger

The shell layer of the toner particles may include a radical scavenger in consideration of a color forming property and resistance to fading caused by ultraviolet radiation.

Examples of the radical scavenger include a phenolic compound, a hindered amine compound, a hydroquinone compound, a phenothiazine compound, a nitroso compound, and an N-oxyl compound.

Examples of the phenolic compound include 2,6-di-tert-butyl-4-methylphenol, 2,6-di-tert-butyl-4-ethylphenol, mono-, di-, or tri-(α-methylbenzyl)phenol, 2,2′-methylenebis(4-ethyl-6-tert-butylphenol), 2,2′-methylenebis(4-methyl-6-tert-butylphenol), 4,4′-butylidenebis(3-methyl-6-tert-butylphenol), 4,4′-thiobis(3-methyl-6-tert-butylphenol), 2,5-di-tert-butylhydroquinone, 2,5-di-tert-amylhydroquinone, triethylene glycol-bis-[3-(3-t-butyl-5-methyl-4-hydroxyphenyl) propionate], 1,6-hexanediol-bis[3-(3,5-di-t-butyl-4-hydroxyphenyl) propionate], 2,4-bis-(n-octylthio)-6-(4-hydroxy-3,5-di-t-butylanilino)-1,3,5-triazine, pentaerythrityl-tetrakis[3-(3,5-di-t-butyl-4-hydroxyphenyl)propionate], 2,2-thio-diethylene bis[3-(3,5-di-t-butyl-4-hydroxyphenyl)propionate], octadecyl-3-(3,5-di-t-butyl-4-hydroxyphenyl)propionate, N,N′-hexamethylene bis(3,5-di-t-butyl-4-hydroxy-hydrocinnamamide), 3,5-di-t-butyl-4-hydroxy-benzylphosphonate-diethyl ester, 1,3,5-trimethyl-2,4,6-tris(3,5-di-t-butyl-4-hydroxybenzyl)benzene, bis[3,5-di-t-butyl-4-hydroxybenzyl(ethoxy)phosphinate]calcium, tris-(3,5-di-t-butyl-4-hydroxybenzyl) isocyanurate, 2,4-2,4-bis[(octylthio)methyl]o-cresol, N,N′-bis[3-(3,5-di-t-butyl-4-hydroxyphenyl)propionyl]hydrazine, tris(2,4-di-t-butylphenyl) phosphite, 2-(5-methyl-2-hydroxyphenyl)benzotriazole, 2-[2-hydroxy-3,5-bis(α,α-dimethylbenzyl)phenyl]-2H-benzotriazole, 2-(3,5-di-t-butyl-2-hydroxyphenyl)benzotriazole, 2-(3-t-butyl-5-methyl-2-hydroxyphenyl)-5-chlorobenzotriazole, 2-(3,5-di-t-butyl-2-hydroxyphenyl)-5-chlorobenzotriazole, 2-(3,5-di-t-amyl-2-hydroxyphenyl)benzotriazole, 2-(2′-hydroxy-5′-t-octylphenyl)-benzotriazole, a condensate of methyl-3-[3-t-butyl-5-(2H-benzotriazol-2-yl)-4-hydroxyphenyl]propionate-polyethylene glycol (molecular weight: about 300), a hydroxyphenyl benzotriazole derivative, bis(1,2,2,6,6-pentamethyl-4-piperidyl) 2-(3,5-di-t-butyl-4-hydroxybenzyl)-2-n-butylmalonate, and 2,4-di-t-butylphenyl-3,5-di-t-butyl-4-hydroxybenzoate.

Among the above radical scavengers, the phenolic compound or the hindered amine compound is preferably used and the hindered amine compound is more preferably used in consideration of a color forming property and resistance to fading caused by ultraviolet radiation.

The number of types of the radical scavengers included in the shell layer may be only one or two or more.

The content of the radical scavenger is preferably 0.01% by mass or more and 5% by mass or less, is more preferably 0.01% by mass or more and 2% by mass or less, is further preferably 0.05% by mass or more and 1.0% by mass or less, and is particularly preferably 0.1% by mass or more and 0.8% by mass or less of the total mass of the toner particles in consideration of a color forming property and resistance to fading caused by ultraviolet radiation.

### Peroxide Decomposer

The shell layer of the toner particles preferably includes a peroxide decomposer and more preferably includes both radical scavenger and peroxide decomposer in consideration of a color forming property and resistance to fading caused by ultraviolet radiation. Examples of the peroxide decomposer include a sulfur compound (e.g., a thio ether compound), a phosphorus compound, a dithiocarbamate salt compound, a thiourea compound, and a benzimidazole compound, which are used as antioxidants.

Examples of the peroxide decomposer include sulfur antioxidants, such as dilauryl 3,3′-thiodipropionate and dimyristyl 3,3′-dithiopropionate; and phosphorus antioxidants, such as trisnonylphenyl phosphite and tris(2,4-di-t-butylphenyl) phosphite.

Among these, the phosphorus compound is preferably used and the phosphite compound is more preferably used as a peroxide decomposer in consideration of a color forming property and resistance to fading caused by ultraviolet radiation.

The number of types of the peroxide decomposers included in the shell layer may be only one or two or more.

The content of the peroxide decomposer is preferably 0.01% by mass or more and 5% by mass or less, is more preferably 0.01% by mass or more and 2% by mass or less, is further preferably 0.02% by mass or more and 1.0% by mass or less, and is particularly preferably 0.05% by mass or more and 0.8% by mass or less of the total mass of the toner particles in consideration of a color forming property and resistance to fading caused by ultraviolet radiation.

The total content of the radical scavenger and the peroxide decomposer is preferably 0.01% by mass or more and 5% by mass or less, is more preferably 0.01% by mass or more and 2% by mass or less, is further preferably 0.02% by mass or more and 1.0% by mass or less, and is particularly preferably 0.05% by mass or more and 0.8% by mass or less of the total mass of the toner particles in consideration of a color forming property and resistance to fading caused by ultraviolet radiation.

### Fluorescent Colorant

The core includes a fluorescent colorant.

The fluorescent colorant may be any colorant that has a fluorescent property and is preferably a colorant that has a fluorescent property in the visible region (i.e., at wavelengths of 380 nm or more and 760 nm or less). The light used for exciting the fluorescent colorant is not limited; the light preferably includes at least visible light or ultraviolet light and more preferably includes at least ultraviolet light.

The fluorescent colorant may be either a fluorescent pigment or a fluorescent dye and is preferably a fluorescent dye.

Note that, in the exemplary embodiment, the term “pigment” refers to a colorant the solubilities of which in 100 g of water and cyclohexanone at 23° C. are both less than 0.1 g, while the term “dye” refers to a colorant the solubility of which in 100 g of water or cyclohexanone at 23° C. is 0.1 g or more.

The color of the fluorescent colorant is not limited and may be selected appropriately as needed.

Examples of the fluorescent colorant include a fluorescent pink colorant, a fluorescent red colorant, a fluorescent orange colorant, a fluorescent yellow colorant, a fluorescent green colorant, and a fluorescent purple colorant.

Among these, a fluorescent pink colorant, a fluorescent red colorant, a fluorescent orange colorant, a fluorescent yellow colorant, and a fluorescent green colorant are preferable, a fluorescent pink colorant, a fluorescent yellow colorant, and a fluorescent green colorant are more preferable, and a fluorescent pink colorant is further preferable.

In particular, the fluorescent colorant preferably includes a rhodamine compound in order to enhance the advantageous effects of this exemplary embodiment.

The fluorescent peak wavelength of the spectral reflectance of the fluorescent colorant may be selected appropriately in accordance with an intended color. For example, in the case where a fluorescent pink color is to be represented, the above fluorescent peak wavelength is preferably 560 nm or more and 670 nm or less and is more preferably 580 nm or more and 650 nm or less.

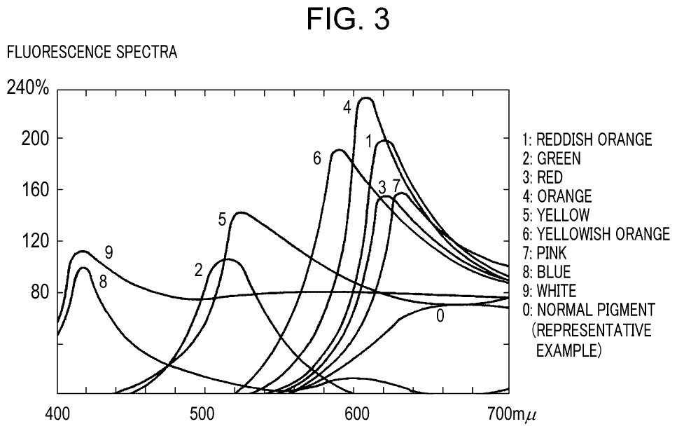

Examples of the spectra of various fluorescent colors are illustrated in FIG. 3, where the vertical axis shows fluorescence intensity, the horizontal axis shows wavelength, and the symbol “mu” means “nm”.

The fluorescent colorants known in the related art may be used as a fluorescent colorant. Specific examples of the fluorescent colorants include C.I. Pigment Yellow 101, Basic Red 1 (Rhodamine 6G), Basic Red 1:1, Basic Red 2, Basic Red 12, Basic Red 13, Basic Red 14, Basic Red 15, Basic Red 36, Basic Violet 7, Basic Violet 10 (Rhodamine B), Basic Violet 11 (Rhodamine 3B), Basic Violet 11:1 (Rhodamine A), Basic Violet 15, Basic Violet 16, Basic Violet 27, Pigment Yellow 101, Basic Yellow 1, Basic Yellow 2, Basic Yellow 9, Basic Yellow 24, Basic Yellow 40, Basic Orange 15, Basic Orange 22, Basic Blue 1, Basic Blue 3, Basic Blue 7, Basic Blue 9, Basic Blue 45, Basic Green 1, Acid Yellow 3, Acid Yellow 7, Acid Yellow 73, Acid Yellow 87, Acid Yellow 184, Acid Yellow 245, Acid Yellow 250, Acid Red 51, Acid Red 52, Acid Red 57, Acid Red 77, Acid Red 87, Acid Red 89, Acid Red 92, Acid Blue 9, Acid Black 2, Solvent Yellow 43, Solvent Yellow 44, Solvent Yellow 85, Solvent Yellow 98, Solvent Yellow 116, Solvent Yellow 131, Solvent Yellow 145, Solvent Yellow 160:1, Solvent Yellow 172, Solvent Yellow 185, Solvent Yellow 195, Solvent Yellow 196, Solvent Orange 63, Solvent Orange 112, Solvent Red 49, Solvent Red 149, Solvent Red 175, Solvent Red 196, Solvent Red 197, Solvent Blue 5, Solvent Green 5, Solvent Green 7, Direct Yellow 27, Direct Yellow 85, Direct Yellow 96, Direct Orange 8, Direct Red 2, Direct Red 9, Direct Blue 22, Direct Blue 199, Direct Green 6, Disperse Yellow 11, Disperse Yellow 82, Disperse Yellow 139, Disperse Yellow 184, Disperse Yellow 186, Disperse Yellow 199, Disperse Yellow 202, Disperse Yellow 232, Disperse Orange 11, Disperse Orange 32, Disperse Red 58, Disperse Red 274, Disperse Red 277, Disperse Red 303, Disperse Blue 7, Reactive Yellow 78, and Vat Red 41.

The number of types of the fluorescent colorants included in the core may be only one or two or more.

The content of the fluorescent colorant is preferably 0.1% by mass or more and 30% by mass or less and is more preferably 0.2% by mass or more and 15% by mass or less of the total mass of the toner particles in consideration of fluorescence intensity and image graininess.

### Colorant Other Than Fluorescent Colorant

The toner particles may include a colorant other than a fluorescent colorant and preferably includes a non-fluorescent pigment. The colorant other than a fluorescent colorant may be included in the core, the shell layer, or both of them.

Specific examples of the colorant other than a fluorescent colorant include magenta pigments, such as C. I. Pigment Red 1, 2, 3, 4, 5, 6, 7, 8, 9, 10, 11, 12, 14, 15, 16, 17, 18, 21, 22, 23, 31, 32, 38, 41, 48, 48:1, 48:2, 48:3, 48:4, 49, 52, 53:1, 54, 57:1, 58, 60:1, 63, 64:1, 68, 81:1, 81:4, 83, 88, 89, 112, 114, 122, 123, 144, 146, 149, 150, 166, 170, 176, 177, 178, 179, 184, 185, 187, 202, 206, 207, 208, 209, 210, 220, 221, 238, 242, 245, 253, 254, 255, 256, 258, 264, 266, 269, and 282 and Pigment Violet 19; magenta dyes, such as C. I. Solvent Red 1, 3, 8, 23, 24, 25, 27, 30, 49, 52, 58, 63, 81, 82, 83, 84, 100, 109, 111, 121, and 122, C. I. Disperse Red 9, and C. I. Basic Red 1, 2, 9, 12, 13, 14, 15, 17, 18, 22, 23, 24, 27, 29, 32, 34, 35, 36, 37, 38, 39, and 40; and various pigments and dyes, such as bengara, cadmium red, red lead, mercury sulfide, permanent red 4R, lithol red, pyrazolone red, watching red, calcium salt, lake red D, brilliant carmine 6B, eosine lake, rhodamine lake B, alizarin lake, brilliant carmine 3B, carbon black, chrome yellow, hansa yellow, benzidine yellow, threne yellow, quinoline yellow, pigment yellow, permanent orange GTR, pyrazolone orange, vulcan orange, brilliant carmine 3B, brilliant carmine 6B, dupont oil red, lake red C, aniline blue, ultramarine blue, calco oil blue, methylene blue chloride, phthalocyanine blue, pigment blue, phthalocyanine green, and malachite green oxalate.

The above colorants other than fluorescent colorants may be used alone or in combination of two or more.

The colorants other than fluorescent colorants may be subjected to a surface treatment as needed and may be used in combination of a dispersing agent. A plurality of types of the colorants may be used in combination.

The content of the colorants other than fluorescent colorants is preferably 0.1% by mass or more and 30% by mass or less and is more preferably 0.5% by mass or more and 15% by mass or less of the total amount of the toner particles in consideration of fluorescence intensity and color reproducibility.

### Binder Resin

The toner particles include a binder resin. Both core and shell layer may include a binder resin.

Examples of the binder resin include vinyl resins that are homopolymers of the following monomers or copolymers of two or more monomers selected from the following monomers: styrenes, such as styrene, para-chlorostyrene, and α-methylstyrene; (meth)acrylates, such as methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, and 2-ethylhexyl methacrylate; ethylenically unsaturated nitriles, such as acrylonitrile and methacrylonitrile; vinyl ethers, such as vinyl methyl ether and vinyl isobutyl ether; vinyl ketones, such as vinyl methyl ketone, vinyl ethyl ketone, and vinyl isopropenyl ketone; and olefins, such as ethylene, propylene, and butadiene.

Examples of the binder resin further include non-vinyl resins, such as epoxy resins, polyester resins, polyurethane resins, polyamide resins, cellulose resins, polyether resins, and modified rosins; a mixture of the non-vinyl resin and the vinyl resin; and a graft polymer produced by polymerization of the vinyl monomer in the presence of the non-vinyl resin.

The above binder resins may be used alone or in combination of two or more.

The binder resin may be a polyester resin.

Examples of the polyester resin include the amorphous polyester resins known in the related art. As a polyester resin, an amorphous polyester resin may be used in combination with a crystalline polyester resin. In such a case, the content of the crystalline polyester resin may be 2% by mass or more and 40% by mass or less and is preferably 5% by mass or more and 25% by mass or less of the total amount of all the binder resins.

The term “crystalline” used herein for resins refers to a property of exhibiting a distinct endothermic peak instead of a step-like endothermic change in DSC, that is, specifically, a property of exhibiting an endothermic peak with a half-width of 10° C. or less at a heating rate of 10° C./min.

The term “amorphous” used herein for resins refers to a property of having a half-width of more than 10° C., a property of exhibiting a step-like endothermic change, or a property of not exhibiting a distinct endothermic peak.

### Amorphous Polyester Resin

Examples of the amorphous polyester resin include condensation polymers of a polyvalent carboxylic acid and a polyhydric alcohol. The amorphous polyester resin may be a commercially available one or a synthesized one.

Examples of the polyvalent carboxylic acid include aliphatic dicarboxylic acids, such as oxalic acid, malonic acid, maleic acid, fumaric acid, citraconic acid, itaconic acid, glutaconic acid, succinic acid, alkenyl succinic acid, adipic acid, and sebacic acid; alicyclic dicarboxylic acids, such as cyclohexanedicarboxylic acid; aromatic dicarboxylic acids, such as terephthalic acid, isophthalic acid, phthalic acid, and naphthalenedicarboxylic acid; anhydrides of these dicarboxylic acids; and lower (e.g., 1 to 5 carbon atoms) alkyl esters of these dicarboxylic acids. Among these polyvalent carboxylic acids, aromatic dicarboxylic acids may be used.

Trivalent or higher carboxylic acids having a crosslinked structure or a branched structure may be used as a polyvalent carboxylic acid in combination with the dicarboxylic acids. Examples of the trivalent or higher carboxylic acids include trimellitic acid, pyromellitic acid, anhydrides of these carboxylic acids, and lower (e.g., 1 to 5 carbon atoms) alkyl esters of these carboxylic acids.

The above polyvalent carboxylic acids may be used alone or in combination of two or more.

Examples of the polyhydric alcohol include aliphatic diols, such as ethylene glycol, diethylene glycol, triethylene glycol, propylene glycol, butanediol, hexanediol, and neopentyl glycol; alicyclic diols, such as cyclohexanediol, cyclohexanedimethanol, and hydrogenated bisphenol A; and aromatic diols, such as bisphenol A-ethylene oxide adduct and bisphenol A-propylene oxide adduct. Among these polyhydric alcohols, for example, aromatic diols and alicyclic diols may be used. In particular, aromatic diols may be used.

Trihydric or higher alcohols having a crosslinked structure or a branched structure may be used as a polyhydric alcohol in combination with the diols. Examples of the trihydric or higher alcohols include glycerin, trimethylolpropane, and pentaerythritol.

The above polyhydric alcohols may be used alone or in combination of two or more.

The glass transition temperature Tg of the amorphous polyester resin is preferably 50° C. or more and 80° C. or less and is more preferably 50° C. or more and 65° C. or less. The glass transition temperature of a resin is determined from a differential scanning calorimetry (DSC) curve obtained by DSC. More specifically, the glass transition temperature of a resin is determined from the “extrapolated glass-transition-starting temperature” according to a method for determining glass transition temperature which is described in JIS K 7121:1987 “Testing Methods for Transition Temperatures of Plastics”.

The weight average molecular weight Mw of the amorphous polyester resin is preferably 5,000 or more and 1,000,000 or less and is more preferably 7,000 or more and 500,000 or less.

The number average molecular weight Mn of the amorphous polyester resin may be 2,000 or more and 100,000 or less.

The molecular weight distribution index Mw/Mn of the amorphous polyester resin is preferably 1.5 or more and 100 or less and is more preferably 2 or more and 60 or less.

The weight average molecular weight and number average molecular weight of a resin are determined by gel permeation chromatography (GPC). Specifically, the molecular weights of a resin are determined by GPC using a “HLC-8120GPC” produced by Tosoh Corporation as measuring equipment, a column “TSKgel SuperHM-M (15 cm)” produced by Tosoh Corporation, and a tetrahydrofuran (THF) solvent. The weight average molecular weight and number average molecular weight of the resin are determined on the basis of the results of the measurement using a molecular-weight calibration curve based on monodisperse polystyrene standard samples.

The amorphous polyester resin may be produced by any suitable production method known in the related art. Specifically, the amorphous polyester resin may be produced by, for example, a method in which polymerization is performed at 180° C. or more and 230° C. or less, the pressure inside the reaction system is reduced as needed, and water and alcohols that are generated by condensation are removed.

In the case where the raw materials, that is, the monomers, are not dissolved in or miscible with each other at the reaction temperature, a solvent having a high boiling point may be used as a dissolution adjuvant in order to dissolve the raw materials. In such a case, the condensation polymerization reaction is performed while the dissolution adjuvant is distilled away. In the case where a monomer having low miscibility is present, a condensation reaction of the monomers with an acid or alcohol that is to undergo a polycondensation reaction with the monomers may be performed in advance and subsequently polycondensation of the resulting polymers with the other components may be performed.

### Crystalline Polyester Resin

Examples of the crystalline polyester resin include condensation polymers of a polyvalent carboxylic acid and a polyhydric alcohol. The crystalline polyester resin may be commercially available one or a synthesized one.

In order to increase ease of forming a crystal structure, a condensation polymer prepared from linear aliphatic polymerizable monomers may be used as a crystalline polyester resin instead of a condensation polymer prepared from polymerizable monomers having an aromatic ring.

Examples of the polyvalent carboxylic acid include aliphatic dicarboxylic acids, such as oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, and 1,18-octadecanedicarboxylic acid; aromatic dicarboxylic acids, such as dibasic acids (e.g., phthalic acid, isophthalic acid, terephthalic acid, and naphthalene-2,6-dicarboxylic acid); anhydrides of these dicarboxylic acids; and lower (e.g., 1 to 5 carbon atoms) alkyl esters of these dicarboxylic acids.

Trivalent or higher carboxylic acids having a crosslinked structure or a branched structure may be used as a polyvalent carboxylic acid in combination with the dicarboxylic acids. Examples of the trivalent carboxylic acids include aromatic carboxylic acids, such as 1,2,3-benzenetricarboxylic acid, 1,2,4-benzenetricarboxylic acid, and 1,2,4-naphthalenetricarboxylic acid; anhydrides of these tricarboxylic acids; and lower (e.g., 1 to 5 carbon atoms) alkyl esters of these tricarboxylic acids.

Dicarboxylic acids including a sulfonic group and dicarboxylic acids including an ethylenic double bond may be used as a polyvalent carboxylic acid in combination with the above dicarboxylic acids.

The above polyvalent carboxylic acids may be used alone or in combination of two or more.

Examples of the polyhydric alcohol include aliphatic diols, such as linear aliphatic diols including a backbone having 7 to 20 carbon atoms. Examples of the aliphatic diols include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosanedecanediol. Among these aliphatic diols, 1,8-octanediol, 1,9-nonanediol, and 1,10-decanediol may be used.

Trihydric or higher alcohols having a crosslinked structure or a branched structure may be used as a polyhydric alcohol in combination with the above diols. Examples of the trihydric or higher alcohols include glycerin, trimethylolethane, trimethylolpropane, and pentaerythritol.

The above polyhydric alcohols may be used alone or in combination of two or more.

The content of the aliphatic diols in the polyhydric alcohol may be 80 mol % or more and is preferably 90 mol % or more.

The melting temperature of the crystalline polyester resin is preferably 50° C. or more and 100° C. or less, is more preferably 55° C. or more and 90° C. or less, and is further preferably 60° C. or more and 85° C. or less.

The above melting temperature is determined from the “melting peak temperature” according to a method for determining melting temperature which is described in JIS K 7121:1987 “Testing Methods for Transition Temperatures of Plastics” using a differential scanning calorimetry (DSC) curve obtained by DSC.

The weight-average molecular weight Mw of the crystalline polyester resin may be 6,000 or more and 35,000 or less.

The crystalline polyester resin may be produced by a production method known in the related art as in, for example, the preparation of the amorphous polyester above.

The content of the binder resin is, for example, preferably 40% by mass or more and 95% by mass or less, is more preferably 50% by mass or more and 90% by mass or less, and is further preferably 60% by mass or more and 85% by mass or less of the total amount of the toner particles.

### Release Agent

Examples of the release agent include, but are not limited to, hydrocarbon waxes; natural waxes, such as a carnauba wax, a rice bran wax, and a candelilla wax; synthetic or mineral-petroleum-derived waxes, such as a montan wax; and ester waxes, such as a fatty-acid ester wax and a montanate wax.

The melting temperature of the release agent is preferably 50° C. or more and 110° C. or less and is more preferably 60° C. or more and 100° C. or less.

The above melting temperature is determined from the “melting peak temperature” according to a method for determining melting temperature which is described in JIS K 7121:1987 “Testing Methods for Transition Temperatures of Plastics” using a differential scanning calorimetry (DSC) curve obtained by DSC.

The content of the release agent is, for example, preferably 1% by mass or more and 20% by mass or less and is more preferably 5% by mass or more and 15% by mass or less of the total amount of the toner particles.

### Other Additives

Examples of the other additives include additives known in the related art, such as a magnetic substance, a charge-controlling agent, and an inorganic powder. These additives may be added to the toner particles as internal additives.

### Properties, Etc. of Toner Particles

The toner particles have a “core-shell” structure constituted by a core and a coating layer (i.e., shell layer) covering the core.

The volume average diameter D50v of the toner particles is preferably 2 m or more and 10 m or less and is more preferably 4 m or more and 8 m or less.

The various average particle sizes and various particle size distribution indices of the toner particles are measured using “COULTER MULTISIZER II” produced by Beckman Coulter, Inc. with an electrolyte “ISOTON-II” produced by Beckman Coulter, Inc. in the following manner.

A sample to be measured (0.5 mg or more and 50 mg or less) is added to 2 ml of a 5% aqueous solution of a surfactant (e.g., sodium alkylbenzene sulfonate) that serves as a dispersant. The resulting mixture is added to 100 ml or more and 150 ml or less of an electrolyte.

The resulting electrolyte containing the sample suspended therein is subjected to a dispersion treatment for 1 minute using an ultrasonic disperser, and the distribution of the diameters of particles having a diameter of 2 m or more and 60 m or less is measured using COULTER MULTISIZER II with an aperture having a diameter of 100 m. The number of the particles sampled is 50,000.

The particle diameter distribution measured is divided into a number of particle diameter ranges (i.e., channels). For each range, in ascending order in terms of particle diameter, the cumulative volume and the cumulative number are calculated and plotted to draw cumulative distribution curves. Particle diameters at which the cumulative volume and the cumulative number reach 16% are considered to be the volume particle diameter D16v and the number particle diameter D16p, respectively. Particle diameters at which the cumulative volume and the cumulative number reach 50% are considered to be the volume average particle diameter D50v and the number average particle diameter D50p, respectively. Particle diameters at which the cumulative volume and the cumulative number reach 84% are considered to be the volume particle diameter D84v and the number particle diameter D84p, respectively.

Using the volume particle diameters and number particle diameters measured, the volume particle size distribution index (GSDv) is calculated as (D84v/D16v)^{1/2} and the number particle size distribution index (GSDp) is calculated as (D84p/D16p)^{1/2}

The toner particles preferably have an average circularity of 0.94 or more and 1.00 or less. The average circularity of the toner particles is more preferably 0.95 or more and 0.98 or less.

The average circularity of the toner particles is determined as [Equivalent circle perimeter]/[Perimeter](i.e., [Perimeter of a circle having the same projection area as the particles]/[Perimeter of the projection image of the particles]. Specifically, the average circularity of the toner particles is determined by the following method.

The toner particles to be measured are sampled by suction so as to form a flat stream. A static image of the particles is taken by instantaneously flashing a strobe light. The image of the particles is analyzed with a flow particle image analyzer “FPIA-3000” produced by Sysmex Corporation. The number of samples used for determining the average circularity of the toner particles is 3,500.

In the case where the toner includes an external additive, the toner (i.e., the developer) to be measured is dispersed in water containing a surfactant and then subjected to an ultrasonic wave treatment in order to remove the external additive from the toner particles.

### External Additive

Examples of the external additive include inorganic particles. Examples of the inorganic particles include SiO₂ particles, TiO₂ particles, Al₂O₃ particles, CuO particles, ZnO particles, SnO₂ particles, CeO₂ particles, Fe₂O₃ particles, MgO particles, BaO particles, CaO particles, K₂O particles, Na₂O particles, ZrO₂ particles, CaO SiO₂ particles, K₂O·(TiO₂)ₙ particles, Al₂O₃ 2SiO₂ particles, CaCO₃ particles, MgCO₃ particles, BaSO₄ particles, and MgSO₄ particles.

The surfaces of the inorganic particles used as an external additive may be subjected to a hydrophobic treatment. The hydrophobic treatment is performed by, for example, immersing the inorganic particles in a hydrophobizing agent. Examples of the hydrophobizing agent include, but are not limited to, a silane coupling agent, a silicone oil, a titanate coupling agent, and aluminum coupling agent. These hydrophobizing agents may be used alone or in combination of two or more.

The amount of the hydrophobizing agent is commonly, for example, 1 part by mass or more and 10 parts by mass or less relative to 100 parts by mass of the inorganic particles.

Examples of the external additive further include particles of a resin, such as polystyrene, polymethyl methacrylate (PMMA), or a melamine resin; and particles of a cleaning lubricant, such as a metal salt of a higher fatty acid, such as zinc stearate, or a fluorine-contained resin.

The amount of the external additive used is, for example, preferably 0.01% by mass or more and 5% by mass or less and is more preferably 0.01% by mass or more and 2.0% by mass or less of the amount of the toner particles.

### Method for Producing Electrostatic Image Developing Toner

The electrostatic image developing toner according to this exemplary embodiment is produced by, after the preparation of the toner particles, depositing an external additive on the surfaces of the toner particles.

The toner particles may be prepared by any dry process, such as knead pulverization, or any wet process, such as aggregation coalescence, suspension polymerization, or dissolution suspension. However, a method for preparing the toner particles is not limited thereto, and any suitable method known in the related art may be used. Among these methods, aggregation coalescence may be used in order to prepare the toner particles.

In the case where aggregation coalescence is used for producing the toner particles, the toner particles may be produced by the following steps:
preparing a resin particle dispersion liquid in which particles of a resin that serves as a binder resin are dispersed (i.e., resin particle dispersion liquid preparation step);
preparing a fluorescent colorant dispersion liquid in which particles of a fluorescent colorant are dispersed (i.e., fluorescent colorant dispersion liquid preparation step);
mixing the resin particle dispersion liquid with the fluorescent colorant dispersion liquid and causing the resulting mixed resin particles to aggregate with one another in the mixed dispersion liquid (or a dispersion liquid that further includes another particle dispersion liquid as needed) to form aggregated particles (i.e., aggregated particle formation step); and
heating the resulting aggregated particle dispersion liquid in which the aggregated particles are dispersed to cause fusion and coalescence of the aggregated particles and form toner particles (i.e., fusion and coalescence step).

Each of the above steps is described below in detail.

### Resin Particle Dispersion Liquid Preparation Step

The resin particle dispersion liquid is prepared by, for example, dispersing resin particles in a dispersion medium using a surfactant.

Examples of the dispersion medium used for preparing the resin particle dispersion liquid include aqueous media.

Examples of the aqueous media include water, such as distilled water and ion-exchange water; and alcohols. These aqueous media may be used alone or in combination of two or more.

Examples of the surfactant include anionic surfactants, such as sulfate surfactants, sulfonate surfactants, and phosphate surfactants; cationic surfactants, such as amine salt surfactants and quaternary ammonium salt surfactants; and nonionic surfactants, such as polyethylene glycol surfactants, alkylphenol ethylene oxide adduct surfactants, and polyhydric alcohol surfactants. Among these surfactants, in particular, the anionic surfactants and the cationic surfactants may be used. The nonionic surfactants may be used in combination with the anionic surfactants and the cationic surfactants.

These surfactants may be used alone or in combination of two or more.

In the preparation of the resin particle dispersion liquid, the resin particles can be dispersed in a dispersion medium by any suitable dispersion method commonly used in the related art in which, for example, a rotary-shearing homogenizer, a ball mill, a sand mill, or a dyno mill that includes media is used. Depending on the type of the resin particles used, the resin particles may be dispersed in the dispersion medium by phase-inversion emulsification. Phase-inversion emulsification is a method in which the resin to be dispersed is dissolved in a hydrophobic organic solvent in which the resin is soluble, a base is added to the resulting organic continuous phase (i.e., O phase) to perform neutralization, and subsequently an aqueous medium (i.e., W phase) is charged in order to perform phase inversion from W/O to O/W and disperse the resin in the aqueous medium in the form of particles.

The volume average size of the resin particles dispersed in the resin particle dispersion liquid is preferably, for example, 0.01 m or more and 1 m or less, is more preferably 0.08 m or more and 0.8 m or less, and is further preferably 0.1 m or more and 0.6 m or less. The volume average size of the resin particles is determined in the following manner. The particle diameter distribution of the resin particles is obtained using a laser-diffraction particle-size-distribution measurement apparatus, such as “LA-700” produced by HORIBA, Ltd. The particle diameter distribution measured is divided into a number of particle diameter ranges (i.e., channels). For each range, in ascending order in terms of particle diameter, the cumulative volume is calculated and plotted to draw a cumulative distribution curve. A particle diameter at which the cumulative volume reaches 50% is considered to be the volume particle diameter D50v. The volume average sizes of particles included in the other dispersion liquids are also determined in the above-described manner.

The content of the resin particles included in the resin particle dispersion liquid is preferably 5% by mass or more and 50% by mass or less and is more preferably 10% by mass or more and 40% by mass or less.

The fluorescent colorant particle dispersion liquid, the release agent particle dispersion liquid, ultraviolet absorber dispersion liquid, and the like are also prepared as in the preparation of the binder resin particle dispersion liquid. In other words, the above-described specifications for the volume average diameter of the particles included in the binder resin particle dispersion liquid, the dispersion medium of the binder resin particle dispersion liquid, the dispersion method used for preparing the binder resin particle dispersion liquid, and the content of the particles in the binder resin particle dispersion liquid can also be applied to the fluorescent colorant particles dispersed in the fluorescent colorant particle dispersion liquid, the release agent particles dispersed in the release agent particle dispersion liquid, and the ultraviolet absorber dispersed in the ultraviolet absorber dispersion liquid.

The radical scavenger dispersion liquid and the peroxide decomposer dispersion liquid may be prepared by, for example, dissolving the radical scavenger or peroxide decomposer in a dispersion medium.

Examples of the dispersion medium used for preparing the radical scavenger dispersion liquid or peroxide decomposer dispersion liquid include an aqueous medium. Examples of the aqueous medium include water, such as distilled water or ion-exchange water, and alcohols. The above aqueous media may be used alone or in combination of two or more.

The contents of the radical scavenger and peroxide decomposer in the radical scavenger dispersion liquid and peroxide decomposer dispersion liquid are preferably 5% by mass or more and 50% by mass or less and are more preferably 10% by mass or more and 40% by mass or less.

### Aggregated Particle Formation Step

The resin particle dispersion liquid is mixed with the fluorescent colorant particle dispersion liquid and the release agent particle dispersion liquid. In the resulting mixed dispersion liquid, heteroaggregation of the resin particles with the fluorescent colorant particles and the release agent particles is performed in order to form aggregated particles including the resin particles, the fluorescent colorant particles, and the release agent particles, the aggregated particles having a diameter closer to that of the intended toner particles.

Specifically, for example, a coagulant is added to the mixed dispersion liquid, and the pH of the mixed dispersion liquid is controlled to be acidic (e.g., pH of 2 or more and 5 or less). A dispersion stabilizer may be added to the mixed dispersion liquid as needed. Subsequently, the mixed dispersion liquid is heated to a temperature close to the glass transition temperature of the resin particles (specifically, e.g., [Glass transition temperature of the resin particles—30° C.] or more and [the Glass transition temperature—10° C.] or less), and thereby the particles dispersed in the mixed dispersion liquid are caused to aggregate together to form aggregated particles.

In the aggregated particle formation step, alternatively, for example, the above coagulant may be added to the mixed dispersion liquid at room temperature (e.g., 25° C.) while the mixed dispersion liquid is stirred using a rotary-shearing homogenizer. Then, the pH of the mixed dispersion liquid is controlled to be acidic (e.g., pH of 2 or more and 5 or less), and a dispersion stabilizer may be added to the mixed dispersion liquid as needed. Subsequently, the mixed dispersion liquid is heated in the above-described manner.

Examples of the coagulant include surfactants that have a polarity opposite to that of the surfactant included in the mixed dispersion liquid, inorganic metal salts, and divalent or higher metal complexes. Using a metal complex as a coagulant reduces the amount of surfactant used and, as a result, charging characteristics may be enhanced.

An additive capable of forming a complex or a bond similar to a complex with the metal ions contained in the coagulant may optionally be used in combination with the coagulant. An example of the additive is a chelating agent.

Examples of the inorganic metal salts include metal salts, such as calcium chloride, calcium nitrate, barium chloride, magnesium chloride, zinc chloride, aluminum chloride, and aluminum sulfate; and inorganic metal salt polymers, such as polyaluminum chloride, polyaluminum hydroxide, and calcium polysulfide.

The chelating agent may be a water-soluble chelating agent. Examples of such a chelating agent include oxycarboxylic acids, such as tartaric acid, citric acid, and gluconic acid; and aminocarboxylic acids, such as iminodiacetic acid (IDA), nitrilotriacetic acid (NTA), and ethylenediaminetetraacetic acid (EDTA).

The amount of the chelating agent used is preferably 0.01 parts by mass or more and 5.0 parts by mass or less and is more preferably 0.1 parts by mass or more and less than 3.0 parts by mass relative to 100 parts by mass of the resin particles.

### Second Aggregated Particle Formation Step and Fusion Coalescence Step

The core-shell toner particles are produced by, subsequent to the preparation of the aggregated particle dispersion liquid in which the aggregated particles are dispersed, mixing the aggregated particle dispersion liquid with a resin particle dispersion liquid in which resin particles are dispersed, an ultraviolet absorber dispersion liquid in which an ultraviolet absorber is dispersed, a radical scavenger dispersion liquid in which a radical scavenger is dissolved, and a peroxide decomposer dispersion liquid in which a peroxide decomposer is dissolved, causing aggregation such that the resin particles, the ultraviolet absorber, the radical scavenger, and the peroxide decomposer are adhered onto the surfaces of the aggregated particles to form second aggregated particles, and heating a second aggregated particle dispersion liquid in which the second aggregated particles are dispersed to cause fusion and coalescence of the second aggregated particles and form core-shell toner particles. In the fusion coalescence step, the dispersion liquid in which the second aggregated particles are dispersed is heated to, for example, a temperature equal to or higher than the glass transition temperature of the resin particles (e.g., [Glass transition temperature of the resin particles+10° C.] or more and [the Glass transition temperature+30° C.] or less) in order to perform fusion and coalescence of the second aggregated particles and form core-shell toner particles.

The core-shell toner particles are produced through the above-described steps.

After the completion of the fusion-coalescence step, the toner particles formed in the dispersion liquid are subjected to any suitable cleaning step, solid-liquid separation step, and drying step that are known in the related art in order to obtain dried toner particles. In the cleaning step, the toner particles may be subjected to displacement washing using ion-exchange water to a sufficient degree from the viewpoint of electrification characteristics. Examples of a solid-liquid separation method used in the solid-liquid separation step include suction filtration and pressure filtration from the viewpoint of productivity. Examples of a drying method used in the drying step include freeze-drying, flash drying, fluidized drying, and vibrating fluidized drying from the viewpoint of productivity.

The toner according to the exemplary embodiment is produced by, for example, adding an external additive to the dried toner particles and mixing the resulting toner particles using a V-blender, a HENSCHEL mixer, a Lodige mixer, or the like. Optionally, coarse toner particles may be removed using a vibrating screen classifier, a wind screen classifier, or the like.

### Electrostatic Image Developer

An electrostatic image developer according to an exemplary embodiment includes at least the electrostatic image developing toner according to the above-described exemplary embodiment.

The electrostatic image developer according to this exemplary embodiment may be a single component developer including only the electrostatic image developing toner according to the above-described exemplary embodiment and may be a two-component developer that is a mixture of the above electrostatic image developing toner and a carrier.

The type of the carrier is not limited, and any suitable carrier known in the related art may be used. Examples of the carrier include a coated carrier prepared by coating the surfaces of cores including magnetic powder particles with a resin; a magnetic-powder-dispersed carrier prepared by dispersing and mixing magnetic powder particles in a matrix resin; and a resin-impregnated carrier prepared by impregnating a porous magnetic powder with a resin.

The magnetic-powder-dispersed carrier and the resin-impregnated carrier may also be prepared by coating the surfaces of particles constituting the carrier, that is, core particles, with a resin.

Examples of the magnetic powder include powders of magnetic metals, such as iron, nickel, and cobalt; and powders of magnetic oxides, such as ferrite and magnetite.

Examples of the coat resin and the matrix resin include polyethylene, polypropylene, polystyrene, poly(vinyl acetate), poly(vinyl alcohol), poly(vinyl butyral), poly(vinyl chloride), poly(vinyl ether), poly(vinyl ketone), a vinyl chloride-vinyl acetate copolymer, a styrene-acrylic acid ester copolymer, a straight silicone resin including an organosiloxane bond and the modified products thereof, a fluorine resin, polyester, polycarbonate, a phenolic resin, and an epoxy resin. The coat resin and the matrix resin may optionally include additives, such as conductive particles. Examples of the conductive particles include particles of metals, such as gold, silver, and copper; and particles of carbon black, titanium oxide, zinc oxide, tin oxide, barium sulfate, aluminum borate, and potassium titanate.

The surfaces of the cores can be coated with a resin by, for example, using a coating-layer forming solution prepared by dissolving the coat resin and, as needed, various types of additives in a suitable solvent. The type of the solvent is not limited and may be selected with consideration of the type of the resin used, ease of applying the coating-layer forming solution, and the like.

Specific examples of a method for coating the surfaces of the cores with the coat resin include an immersion method in which the cores are immersed in the coating-layer forming solution; a spray method in which the coating-layer forming solution is sprayed onto the surfaces of the cores; a fluidized-bed method in which the coating-layer forming solution is sprayed onto the surfaces of the cores while the cores are floated using flowing air; and a kneader-coater method in which the cores of the carrier are mixed with the coating-layer forming solution in a kneader coater and subsequently the solvent is removed.

The mixing ratio (i.e., mass ratio) of the toner to the carrier in the two-component developer is preferably toner:carrier=1:100 to 30:100 and is more preferably 3:100 to 20:100.

### Image Forming Apparatus and Image Forming Method

An image forming apparatus and an image forming method according to an exemplary embodiment of the present disclosure are described below.

The image forming apparatus according to this exemplary embodiment includes an image holding member; a charging unit that charges a surface of the image holding member; an electrostatic image formation unit that forms an electrostatic image on the surface of the image holding member; a developing unit that includes an electrostatic image developer and develops the electrostatic image formed on the surface of the image holding member with the electrostatic image developer to form a toner image; a transfer unit that transfers the toner image formed on the surface of the image holding member onto a surface of a recording medium; and a fixing unit that fixes the toner image transferred on the surface of the recording medium. The above electrostatic image developer is the electrostatic image developer according to the above-described exemplary embodiment.

Using the image forming apparatus according to this exemplary embodiment, an image forming method including a charging step of charging a surface of an image holding member; an electrostatic image formation step of forming an electrostatic image on the surface of the image holding member; a developing step of developing the electrostatic image formed on the surface of the image holding member with the electrostatic image developer according to the above-described exemplary embodiment to form a toner image; a transfer step of transferring the toner image formed on the surface of the image holding member onto a surface of a recording medium; and a fixing step of fixing the toner image transferred on the surface of the recording medium (i.e., the image forming method according to this exemplary embodiment) is implemented.

The image forming apparatus according to this exemplary embodiment may be any image forming apparatus known in the related art, such as a direct-transfer image forming apparatus in which a toner image formed on the surface of an image holding member is directly transferred to a recording medium; an intermediate-transfer image forming apparatus in which a toner image formed on the surface of an image holding member is transferred onto the surface of an intermediate transfer body in the first transfer step and the toner image transferred on the surface of the intermediate transfer body is transferred onto the surface of a recording medium in the second transfer step; an image forming apparatus including a cleaning unit that cleans the surface of the image holding member subsequent to the transfer of the toner image before the image holding member is again charged; and an image forming apparatus including a static-eliminating unit that eliminates static by irradiating the surface of an image holding member with static-eliminating light subsequent to the transfer of the toner image before the image holding member is again charged.

In the case where the image forming apparatus according to this exemplary embodiment is the intermediate-transfer image forming apparatus, the transfer unit may be constituted by, for example, an intermediate transfer body to which a toner image is transferred, a first transfer subunit that transfers a toner image formed on the surface of the image holding member onto the surface of the intermediate transfer body in the first transfer step, and a second transfer subunit that transfers the toner image transferred on the surface of the intermediate transfer body onto the surface of a recording medium in the second transfer step.

In the image forming apparatus according to the exemplary embodiment, for example, a portion including the developing unit may have a cartridge structure (i.e., process cartridge) detachably attachable to the image forming apparatus. An example of the process cartridge is a process cartridge including the electrostatic image developer according to the exemplary embodiment and the developing unit.

An example of the image forming apparatus according to the exemplary embodiment is described below, but the image forming apparatus is not limited thereto. Hereinafter, only components illustrated in drawings are described; others are omitted.

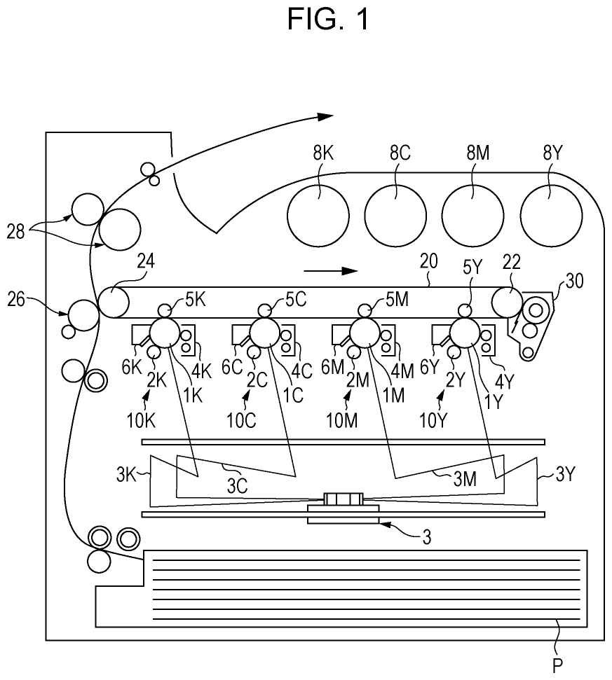

FIG. 1 schematically illustrates the image forming apparatus according to the exemplary embodiment.

The image forming apparatus illustrated in FIG. 1 includes first to fourth electrophotographic image formation units 10Y, 10M, 10C, and 10K that form yellow (Y), magenta (M), cyan (C), and black (K) images, respectively, on the basis of color separation image data. The image formation units (hereinafter, referred to simply as “units”) 10Y, 10M, 10C, and 10K are horizontally arranged in parallel at a predetermined distance from one another. The units 10Y, 10M, 10C., and 10K may be process cartridges detachably attachable to the image forming apparatus.

An intermediate transfer belt 20 that serves as an intermediate transfer body runs above (in FIG. 1) and extends over the units 10Y, 10M, 10C, and 10K. The intermediate transfer belt 20 is wound around a drive roller 22 and a support roller 24 arranged to contact with the inner surface of the intermediate transfer belt 20, which are spaced from each other in a direction from left to right in FIG. 1, and runs clockwise in FIG. 1, that is, in the direction from the first unit 10Y to the fourth unit 10K. Using a spring or the like (not illustrated), a force is applied to the support roller 24 in a direction away from the drive roller 22, thereby applying tension to the intermediate transfer belt 20 wound around the drive roller 22 and the support roller 24. An intermediate transfer body-cleaning device 30 is disposed so as to contact with the image-carrier-side surface of the intermediate transfer belt 20 and to face the drive roller 22.

Developing devices (i.e., developing units) 4Y, 4M, 4C, and 4K of the units 10Y, 10M, 10C, and 10K are supplied with yellow, magenta, cyan, and black toners stored in toner cartridges 8Y, 8M, 8C, and 8K, respectively.

Since the first to fourth units 10Y, 10M, 10C, and 10K have the same structure and the same action, the following description is made with reference to, as a representative, the first unit 10Y that forms an yellow image and is located upstream in a direction in which the intermediate transfer belt runs. Note that components of the second to fourth units 10M, 10C, and 10K which are equivalent to the above-described components of the first unit 10Y are denoted with reference numerals including magenta (M), cyan (C), or black (K) instead of yellow (Y), and the descriptions of the second to fourth units 10M, 10C, and 10K are omitted.

The first unit 10Y includes a photosensitive member 1Y serving as an image holding member. The following components are disposed around the photosensitive member 1Y sequentially in the counterclockwise direction: a charging roller (example of the charging unit) 2Y that charges the surface of the photosensitive member 1Y at a predetermined potential; an exposure device (example of the electrostatic image formation unit) 3 that forms an electrostatic image by irradiating the charged surface of the photosensitive member 1Y with a laser beam 3Y based on a color separated image signal; a developing device (example of the developing unit) 4Y that develops the electrostatic image by supplying a charged toner to the electrostatic image; a first transfer roller (example of the first transfer subunit) 5Y that transfers the developed toner image to the intermediate transfer belt 20; and a photosensitive-member cleaning device (example of the cleaning unit) 6Y that removes a toner remaining on the surface of the photosensitive member 1Y after the first transfer.

The first transfer roller 5Y is disposed so as to contact with the inner surface of the intermediate transfer belt 20 and to face the photosensitive member 1Y. Each of the first transfer rollers 5Y, 5M, 5C, and 5K is connected to a bias power supply (not illustrated) that applies a first transfer bias to the first transfer rollers. Each bias power supply varies the transfer bias applied to the corresponding first transfer roller on the basis of the control by a controller (not illustrated).

The action of forming a yellow image in the first unit 10Y is described below. Before the action starts, the surface of the photosensitive member 1Y is charged at a potential of −600 to −800 V by the charging roller 2Y.

The photosensitive member 1Y is formed by stacking a photosensitive layer on a conductive substrate (e.g., volume resistivity at 20° C.: 1×10⁻⁶ Ωcm or less). The photosensitive layer is normally of high resistance (comparable with the resistance of ordinary resins), but, upon being irradiated with the laser beam 3Y, the specific resistance of the portion irradiated with the laser beam varies. Thus, the exposure device 3 irradiates the surface of the charged photosensitive member 1Y with the laser beam 3Y on the basis of the image data of the yellow image sent from the controller (not illustrated). The laser beam 3Y is impinged on the photosensitive layer formed in the surface of the photosensitive member 1Y. As a result, an electrostatic image of yellow image pattern is formed on the surface of the photosensitive member 1Y.

The term “electrostatic image” used herein refers to an image formed on the surface of the photosensitive member 1Y by charging, the image being a “negative latent image” formed by irradiating a portion of the photosensitive layer with the laser beam 3Y to reduce the specific resistance of the irradiated portion such that the charges on the irradiated surface of the photosensitive member 1Y discharge while the charges on the portion that is not irradiated with the laser beam 3Y remain.

The electrostatic image, which is formed on the photosensitive member 1Y as described above, is sent to the predetermined developing position by the rotating photosensitive member 1Y. The electrostatic image on the photosensitive member 1Y is visualized (i.e., developed) in the form of a toner image by the developing device 4Y at the developing position.

The developing device 4Y includes an electrostatic image developer including, for example, at least, a yellow toner and a carrier. The yellow toner is stirred in the developing device 4Y to be charged by friction and supported on a developer roller (example of the developer support), carrying an electric charge of the same polarity (i.e., negative) as the electric charge generated on the photosensitive member 1Y. The yellow toner is electrostatically adhered to the eliminated latent image portion on the surface of the photosensitive member 1Y as the surface of the photosensitive member 1Y passes through the developing device 4Y. Thus, the latent image is developed using the yellow toner. The photosensitive member 1Y on which the yellow toner image is formed keeps rotating at the predetermined rate, thereby transporting the toner image developed on the photosensitive member 1Y to the predetermined first transfer position.

Upon the yellow toner image on the photosensitive member 1Y reaching the first transfer position, first transfer bias is applied to the first transfer roller 5Y so as to generate an electrostatic force on the toner image in the direction from the photosensitive member 1Y toward the first transfer roller 5Y. Thus, the toner image on the photosensitive member 1Y is transferred to the intermediate transfer belt 20. The transfer bias applied has the opposite polarity (+) to that of the toner (−) and controlled to be, for example, in the first unit 10Y, +10 μA by a controller (not illustrated).

The toner particles remaining on the photosensitive member 1Y are removed by the photosensitive-member cleaning device 6Y and then collected.

Each of the first transfer biases applied to first transfer rollers 5M, 5C, and 5K of the second, third, and fourth units 10M, 10C., and 10K is controlled in accordance with the first unit 10Y.

Thus, the intermediate transfer belt 20, on which the yellow toner image is transferred in the first unit 10Y, is successively transported through the second to fourth units 10M, 10C., and 10K while toner images of the respective colors are stacked on top of another.

The resulting intermediate transfer belt 20 on which toner images of four colors are multiple-transferred in the first to fourth units is then transported to a second transfer section including a support roller 24 contacting with the inner surface of the intermediate transfer belt 20 and a second transfer roller (example of the second transfer subunit) 26 disposed on the image-carrier-side of the intermediate transfer belt 20. A recording paper (example of the recording medium) P is fed by a feed mechanism into a narrow space between the second transfer roller 26 and the intermediate transfer belt 20 that contact with each other at the predetermined timing. The second transfer bias is then applied to the support roller 24. The transfer bias applied here has the same polarity (−) as that of the toner (−) and generates an electrostatic force on the toner image in the direction from the intermediate transfer belt 20 toward the recording paper P. Thus, the toner image on the intermediate transfer belt 20 is transferred to the recording paper P. The intensity of the second transfer bias applied is determined on the basis of the resistance of the second transfer section which is detected by a resistance detector (not illustrated) that detects the resistance of the second transfer section and controlled by changing voltage.

Subsequently, the recording paper P is transported into a nip part of the fixing device (example of the fixing unit) 28 at which a pair of fixing rollers contact with each other. The toner image is fixed to the recording paper P to form a fixed image.

Examples of the recording paper P to which a toner image is transferred include plain paper used in electrophotographic copiers, printers, and the like. Instead of the recording paper P, OHP films and the like may be used as a recording medium.

The surface of the recording paper P may be smooth in order to enhance the smoothness of the surface of the fixed image. Examples of such a recording paper include coated paper produced by coating the surface of plain paper with resin or the like and art paper for printing.

The recording paper P, to which the color image has been fixed, is transported toward an exit portion. Thus, the series of the steps for forming a color image are terminated.

### Process Cartridge and Toner Cartridge

A process cartridge according to the exemplary embodiment is described below.

The process cartridge according to the exemplary embodiment includes a developing unit that includes the electrostatic image developer according to the exemplary embodiment and develops an electrostatic image formed on the surface of an image holding member with the electrostatic image developer to form a toner image. The process cartridge according to the exemplary embodiment is detachably attachable to an image forming apparatus.

The structure of the process cartridge according to the exemplary embodiment is not limited to the above-described one. The process cartridge according to the exemplary embodiment may further include, in addition to the developing device, at least one unit selected from an image holding member, a charging unit, an electrostatic image formation unit, a transfer unit, etc.

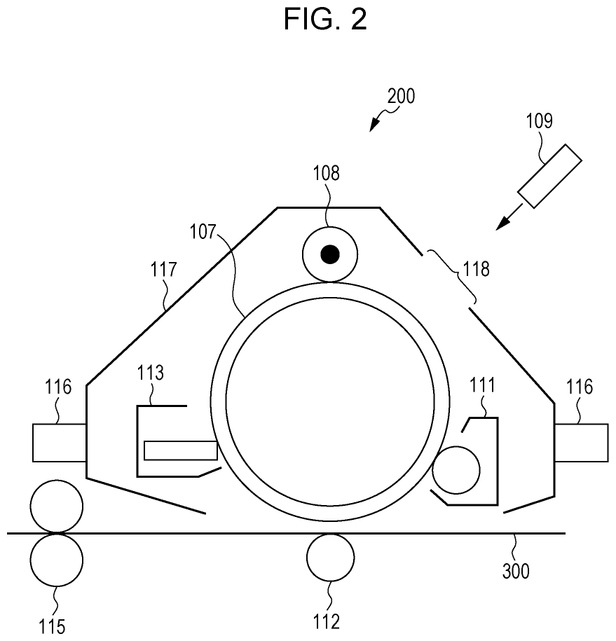

An example of the process cartridge according to the exemplary embodiment is described below, but the process cartridge is not limited thereto. Hereinafter, only components illustrated in FIG. 2 are described; others are omitted.

FIG. 2 schematically illustrates the process cartridge according to the exemplary embodiment.

A process cartridge 200 illustrated in FIG. 2 includes, for example, a photosensitive member 107 (example of the image holding member), a charging roller 108 (example of the charging unit) disposed on the periphery of the photosensitive member 107, a developing device 111 (example of the developing unit), and a photosensitive-member cleaning device 113 (example of the cleaning unit), which are combined into one unit using a housing 117 to form a cartridge. The housing 117 has an aperture 118 for exposure. A mounting rail 116 is disposed on the housing 117.

In FIG. 2, Reference numeral 109 denotes an exposure device (example of the electrostatic image formation unit), Reference numeral 112 denotes a transfer device (example of the transfer unit), Reference numeral 115 denotes a fixing device (example of the fixing unit), and Reference numeral 300 denotes recording paper (example of the recording medium).

A toner cartridge according to the exemplary embodiment is described below.

The toner cartridge according to the exemplary embodiment is a toner cartridge that includes the toner according to the exemplary embodiment and is detachably attachable to an image forming apparatus. The toner cartridge includes a replenishment toner that is to be supplied to the developing unit disposed inside an image forming apparatus.

The image forming apparatus illustrated in FIG. 1 is an image forming apparatus that includes the toner cartridges 8Y, 8M, 8C, and 8K detachably attached to the image forming apparatus. Each of the developing devices 4Y, 4M, 4C, and 4K is connected to a specific one of the toner cartridges which corresponds to the color of the developing device with a toner supply pipe (not illustrated). When the amount of toner contained in a toner cartridge is small, the toner cartridge is replaced.

### EXAMPLES

Exemplary embodiments of the present disclosure are described in detail with reference to Examples below. It should be noted that the exemplary embodiments of the present disclosure are not limited by Examples.

Hereinafter, all “part” and “%” are on a mass basis unless otherwise specified.

In Examples, synthesis, treatment, production, and the like are conducted at room temperature (25° C.±3° C.) unless otherwise specified.

### Example 1

### Preparation of Toner

### Preparation of Fluorescent Colorant Dispersion Liquid

Rhodamine-based fluorescent colorant “Rhodamine 6G” produced by Tokyo Chemical Industry Co., Ltd.: 15.8 parts
Acetylacetone metal compound: 34.2 parts
Anionic surfactant “Neogen RK” produced by Dai-ichi Kogyo Seiyaku Co., Ltd.: 5 parts
Ion-exchange water: 193 parts

The above components are mixed together, and the resulting mixture is subjected to “Ultimizer” produced by Sugino Machine Limited at 240 MPa for 10 minutes to form a fluorescent colorant dispersion liquid (solid content: 20%).

### Preparation of Resin Particle Dispersion Liquid (1)

### Materials for Oil Phase

Dodecanedioic acid produced by Tokyo Chemical Industry Co., Ltd.: 20.8 parts
1,9-Nonanediol produced by Tokyo Chemical Industry Co., Ltd.: 20.5 parts
Dodecanethiol produced by FUJIFILM Wako Pure Chemical Corporation: 0.4 parts

### Materials for Water Phase 1

Ion-exchange water: 17 parts
Anionic surfactant “Dowfax (Rhodia)” produced by The Dow Chemical Company: 0.4 parts

### Materials for Water Phase 2

Ion-exchange water: 40 parts
Anionic surfactant “Dowfax (Rhodia)” produced by The Dow Chemical Company: 0.05 parts
Ammonium peroxodisulfate produced by FUJIFILM Wako Pure Chemical Corporation: 0.4 parts

The materials for an oil phase are mixed with one another while stirred. The materials for a water phase 1 are also mixed with one another while stirred. The resulting two mixtures are mixed with each other while stirred to form a dispersion liquid containing emulsified monomers. The materials for a water phase 2 are charged into another reactor. The inside of the reactor is sufficiently purged with nitrogen. While stirring is performed, heating is performed with an oil bath until the temperature inside the reaction system reaches 75° C. The dispersion liquid containing emulsified monomers is added dropwise to the reactor over 3 hours gradually in order to perform emulsion polymerization. After the addition of the dispersion liquid has been finished, polymerization is continued at 75° C. and finished after 3 hours. Hereby, a resin particle dispersion liquid having a solid content of 42% by mass is prepared. Ion-exchange water is added to the resin particle dispersion liquid in order to adjust the solid content in the dispersion liquid to 20%. Hereby, a resin particle dispersion liquid (1) is prepared.

The volume-average particle size measured with a particle size distribution analyzer “LA-700” produced by HORIBA, Ltd. is 250 nm. The glass transition temperature of the resin which is measured with a differential scanning calorimeter “DSC-50” produced by Shimadzu Corporation at a heating rate of 10° C./min is 52° C. The number-average molecular weight (polystyrene-equivalent) measured by GPC is 13,000.

Preparation of Resin Particle Dispersion Liquid (2) A resin particle dispersion liquid (2) is prepared as in the preparation of the resin particle dispersion liquid (1), except that the materials for the oil phase of the resin particle dispersion liquid (1) are changed to the following materials.

### Materials for Oil Phase

Styrene produced by FUJIFILM Wako Pure Chemical Corporation: 30 parts
n-Butyl acrylate produced by FUJIFILM Wako Pure Chemical Corporation: 10 parts
β-Carboxyethyl acrylate produced by Rhodia Nicca, Ltd.: 1.3 parts
Dodecanethiol produced by FUJIFILM Wako Pure Chemical Corporation: 0.4 parts

The volume-average particle size measured with a particle size distribution analyzer “LA-700” produced by HORIBA, Ltd. is 250 nm. The glass transition temperature of the resin which is measured with a differential scanning calorimeter “DSC-50” produced by Shimadzu Corporation at a heating rate of 10° C./min is 52° C. The number-average molecular weight (polystyrene-equivalent) measured by GPC is 13,000.

### Preparation of Release Agent Particle Dispersion Liquid

Paraffin wax “HNP-9” produced by Nippon Seiro Co., Ltd.: 100 parts
Anionic surfactant “Neogen RK” produced by Dai-ichi Kogyo Seiyaku Co., Ltd.: 1 part
Ion-exchange water: 350 parts

The above materials are mixed together, and the resulting mixture is heated to 100° C. and dispersed with a homogenizer “ULTRA-TURRAX T50” produced by IKA. Subsequently, further dispersion treatment is performed with a Manton-Gaulin high pressure homogenizer produced by Gaulin. Hereby, a release agent particle dispersion liquid (1) (solid content: 20% by mass), in which release agent particles having a volume average size of 200 nm are dispersed, is prepared.

### Preparation of Ultraviolet Absorber Dispersion Liquid (1)

Triazine compound “Triazine Standard” produced by FUJIFILM Wako Pure Chemical Corporation: 5 parts
Anionic surfactant “Neogen RK” produced by Dai-ichi Kogyo Seiyaku Co., Ltd.: 1 part
Ion-exchange water: 94 parts

The above materials are mixed together, and the resulting mixture is heated to 100° C. and dispersed with a homogenizer “ULTRA-TURRAX T50” produced by IKA. Subsequently, further dispersion treatment is performed with a Manton-Gaulin high pressure homogenizer produced by Gaulin. Hereby, an ultraviolet absorber dispersion liquid (1) (solid content: 5% by mass) is prepared.

### Preparation of Radical Scavenger Dispersion Liquid (1)

Hindered amine compound “ADK STAB LA-52” produced by ADEKA: 5 parts
Ion-exchange water: 95 parts

The above components are mixed together to form a radical scavenger dispersion liquid (solid content: 5% by mass).

### Preparation of Peroxide Decomposer Dispersion Liquid (1)

Phosphite compound “Tris(2,4-di-t-butylphenyl) Phosphite Standard” produced by FUJIFILM Wako Pure Chemical Corporation: 5 parts
Ion-exchange water: 95 parts

The above components are mixed together to form a peroxide decomposer dispersion liquid (solid content: 5% by mass).

### Preparation of Toner Particles

### Materials (1)

Fluorescent colorant dispersion liquid (1): 20 parts
Resin particle dispersion liquid (1): 390 parts
Release agent particle dispersion liquid (1): 40 parts
Anionic surfactant “Neogen RK” (20%) produced by Dai-ichi Kogyo Seiyaku Co., Ltd.: 1 part

### Materials (2)

Resin particle dispersion liquid (1): 200 parts
Ultraviolet absorber dispersion liquid (1): 11 parts
Radical scavenger dispersion liquid (1): 8 parts
Peroxide decomposer dispersion liquid (1): 8 parts

The materials (1) are charged into a round-bottomed, stainless steel flask. After the pH has been adjusted to 3.5 by the addition of 0.1 N (mol/L) nitric acid, 30 parts of an aqueous nitric acid solution having an aluminum sulfate concentration of 10% by mass is added to the flask. The resulting mixture is dispersed with a homogenizer “ULTRA-TURRAX T50” produced by IKA at a liquid temperature of 30° C. and subsequently heated to 45° C. in an oil bath for heating. Then, holding is performed for 30 minutes. Subsequently, the materials (2) are added to the flask, and holding is performed for 1 hour. To the flask, a 0.1-N(mol/L) aqueous sodium hydroxide solution is added in order to adjust the pH to 8.5. Subsequently, the temperature is increased to 85° C. and holding is performed for 2.5 hours. Then, the temperature is reduced to 20° C. at 20° C./min, and the solid component is separated from the liquid by filtering, washed thoroughly with ion-exchange water, and dried. Hereby, toner particles are prepared. The toner particles have a volume-average size of 5 μm.

### Preparation of Carrier

Ferrite particles (average size: 35 m): 100 parts
Toluene: 14 parts
Polymethyl methacrylate (PMMA, weight average molecular weight: 75,000): 5 parts
Carbon black “VXC-72” produced by Cabot Corporation (volume resistivity: 100 Ω·cm or less): 0.2 parts

The above materials except the ferrite particles are dispersed with a sand mill to form a dispersion liquid. The dispersion liquid and the ferrite particles are charged into a degassing vacuum kneader. Then, while stirring is performed, the pressure is reduced and drying is performed. Hereby, a carrier is prepared.

### Preparation of Toner

With 100 parts by mass of the above toner particles, 1.5 parts by mass of hydrophobic silica “RY50” produced by Nippon Aerosil Co., Ltd. and 1.0 parts by mass of hydrophobic titanium oxide “T805” produced by Nippon Aerosil Co., Ltd. are mixed using a sample mill at 10,000 revolutions per minute (rpm) for 30 seconds. Subsequently, sieving is performed with a vibration sieve having an opening of 45 m. Hereby, a toner (1) (i.e., an electrostatic image developing toner) is prepared. The volume average size of the toner is 7 m.

### Preparation of Electrostatic Image Developer

A developer A (i.e., electrostatic image developer) is prepared by mixing 8 parts of the toner with 92 parts of the carrier using a V-blender.

### Examples 2 to 5 and 10 to 19 and Comparative Examples 1 to 5

An electrostatic image developing toner and an electrostatic image developer are prepared as in Example 1, except that the amounts of the ultraviolet absorber, radical scavenger, and peroxide decomposer used are adjusted such that the contents of the ultraviolet absorber, radical scavenger, and peroxide decomposer which are described in Table 1 are achieved.

### Example 6

An electrostatic image developing toner and an electrostatic image developer are prepared as in Example 1, except that the ultraviolet absorber included in the ultraviolet absorber dispersion liquid (1) is changed to a benzophenone compound “Benzophenone” produced by Tokyo Chemical Industry Co., Ltd.

### Example 7

An electrostatic image developing toner and an electrostatic image developer are prepared as in Example 1, except that the radical scavenger included in the radical scavenger dispersion liquid (1) is changed to a hydroquinone compound “Hydroquinone” produced by FUJIFILM Wako Pure Chemical Corporation.

### Example 8

An electrostatic image developing toner and an electrostatic image developer are prepared as in Example 1, except that the peroxide decomposer included in the peroxide decomposer dispersion liquid (1) is changed to a thiourea compound “Chiral Isothiourea” produced by Tokyo Chemical Industry Co., Ltd.

### Example 9

An electrostatic image developing toner and an electrostatic image developer are prepared as in Example 1, except that the resin particle dispersion liquid (1) is changed to the resin particle dispersion liquid (2).

### Comparative Example 3: Non-Core-Shell Toner Particles

An electrostatic image developing toner and an electrostatic image developer are prepared as in Example 1, except that toner particles prepared in the following manner are used.

### Materials

Fluorescent colorant dispersion liquid (1): 20 parts
Resin particle dispersion liquid (1): 590 parts
Release agent particle dispersion liquid (1): 40 parts
Ultraviolet absorber dispersion liquid (1): 11 parts
Radical scavenger dispersion liquid (1): 8 parts
Peroxide decomposer dispersion liquid (1): 8 parts
Anionic surfactant “Neogen RK” (20%) produced by Dai-ichi Kogyo Seiyaku Co., Ltd.: 1 part

The above materials are charged into a round-bottomed, stainless steel flask. After the pH has been adjusted to 3.5 by the addition of 0.1 N nitric acid, 30 parts of an aqueous nitric acid solution having an aluminum sulfate concentration of 10% by mass is added to the flask. The resulting mixture is dispersed with a homogenizer “ULTRA-TURRAX T50” produced by IKA at a liquid temperature of 30° C. and subsequently heated to 45° C. in an oil bath for heating. Then, holding is performed for 2 hours. Subsequently, a 0.1-N aqueous sodium hydroxide solution is added to the flask in order to adjust the pH to 8.5. Subsequently, the temperature is increased to 85° C. and holding is performed for 2.5 hours. Then, the temperature is reduced to 20° C. at 20° C./min, and the solid component is separated from the liquid by filtering, washed thoroughly with ion-exchange water, and dried. Hereby, toner particles are prepared. The toner particles have a volume-average particle size of 5 m.

The electrostatic image developing toners and electrostatic image developers prepared as described above are subjected to the following evaluations.

### Evaluations for Color Forming Property and Resistance to Fading Caused by Ultraviolet Radiation

A developer including one of the above toners is attached to a printer that is a modification of “Revoria Press PC1120” produced by FUJIFILM Business Innovation Corp. After the printer has been adjusted such that the toner density deposited on a paper sheet at 20° C. and 50% is 0.7 mg/cm², a 5 cm×5 cm solid image is formed on J-paper produced by FUJIFILM Business Innovation Corp. in a single-color mode. This image is used as an image sample.

The density of the color of the image sample is measured with a densitometer “X-Rite 938” produced by X-Rite, Inc. and used as a reference color.

Subsequently, a photo-radical polymerizable UV varnish “UV VECTA Coating Varnish PC-3KW2” produced by T&K TOKA Co., Ltd. is applied to the image sample with a wire bar to form a coating layer having a thickness of 6 μm. The coating layer is irradiated with ultraviolet radiation using an ultraviolet irradiation apparatus including a mercury lamp serving as a light source, such that the total amount of light received on the surface of the fixed image is 100 mJ/cm². As a result, the UV varnish coating layer is cured to form a varnish layer. The density of the color of the image sample is measured with the above-described densitometer before and after the UV-vanishing has been performed.

A color difference ΔE that occurs during the UV varnishing is calculated on the basis of the above measurement values using the following formula.

ΔE=[(L_{bef}−L_{aft})₂+(a_{bef}−a_{aft})₂+(b_{bef}−b_{aft})²]^{1/2}
where L_{bef}, a_{bef}, and b_{bef} represent L, a, and b measured prior to the UV varnishing, and L_{aft}, a_{aft}, and b_{aft} represent L, a, and b measured subsequent to the UV varnishing.
ΔE is evaluated in accordance with the following standard. The smaller the ΔE value, the higher the resistance to fading caused by ultraviolet radiation. Samples evaluated as “A” to “C” are considered acceptable in practical use.
A: ΔE is less than 0.5
B: ΔE is 0.5 or more and less than 1.5
C: ΔE is 1.5 or more and less than 3.0
D: ΔE is 3.0 or more

Moreover, a difference ΔE2 between the color of the image prior or subsequent to the UV varnishing and the target color (DIC 584B) is calculated using the following formula.

ΔE2=[(L_{bef}−LTC)²+(a_{bef}−aTC)²+(b_{bef}−bTC)²]^{1/2}
where LTC, aTC, and bTC represent L, a, and b of the target color.
ΔE2 is evaluated in accordance with the following standard. The smaller the ΔE2 value, the higher the color forming property. Samples evaluated as “A” to “C” are considered acceptable in practical use.
A: ΔE2 is less than 0.2
B: ΔE2 is 0.2 or more and less than 0.4
C: ΔE2 is 0.4 or more and less than 0.6
D: ΔE2 is 0.6 or more

Table 1 summarizes the evaluation results.

TABLE 1

| | | | | Evaluation of | Evaluation |
|---|---|---|---|---|---|
| | Content of | Content of | Content of | resistance to | of color |
| | ultraviolet | radical | peroxide | fading by UV | forming |
| | absorber | scavenger | decomposer | radiation | property |
| | (mass %) | (mass %) | (mass %) | (ΔE) | (ΔE2) |
| Example 1 | 0.4 | 0.3 | 0.3 | A | A |
| Example 2 | 0.5 | 0.05 | 0.05 | A | A |
| Example 3 | 0.1 | 0.9 | 0.9 | A | A |
| Example 4 | 0.1 | 0.3 | 0.3 | A | A |
| Example 5 | 1.8 | 0.05 | 0.04 | A | B |
| Example 6 | 0.4 | 0.3 | 0.3 | B | A |
| Example 7 | 0.4 | 0.3 | 0.3 | B | A |
| Example 8 | 0.4 | 0.3 | 0.3 | B | A |
| Example 9 | 0.4 | 0.3 | 0.3 | B | A |
| Example 10 | 0.01 | 0.3 | 0.3 | A | B |
| Example 11 | 10 | 0.3 | 0.3 | A | B |
| Example 12 | 12 | 0.3 | 0.3 | A | C |
| Example 13 | 0.4 | 0.03 | 0.03 | B | A |
| Example 14 | 0.4 | 0.02 | 0.02 | C | A |
| Example 15 | 0.4 | 2.5 | 2.5 | B | A |
| Example 16 | 0.4 | 3 | 3 | C | B |
| Example 17 | 1.5 | 0.3 | 0.3 | A | A |
| Example 18 | 0.4 | 0 | 0.3 | A | A |
| Example 19 | 0.4 | 0.3 | 0 | A | A |
| Comparative | 1.0 | 0 | 0 | D | A |
| Example 1 | | | | | |
| Comparative | 0 | 0.5 | 0.5 | D | A |
| Example 2 | | | | | |
| Comparative | 0.4 | 0.3 | 0.3 | D | A |
| Example 3 | | | | | |

Note that, in Table 1, the contents of the ultraviolet absorber, radical scavenger, and peroxide decomposer are proportions relative to the total mass of the toner particles.

As listed in Table 1, the electrostatic image developing toners prepared in Examples 1 to 17 are excellent in terms of resistance to fading caused by ultraviolet radiation, compared with the electrostatic image developing toners prepared in Comparative Examples 1 to 3.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1))) A core-shell electrostatic image developing toner including:
toner particles including a binder resin and a fluorescent colorant,
the toner particles having a structure including a core and a shell layer,
the core including the fluorescent colorant,
the shell layer including an ultraviolet absorber and at least one selected from the group consisting of a radical scavenger and a peroxide decomposer.

(((2))) The electrostatic image developing toner according to (((1))),
wherein a content of the ultraviolet absorber is 0.01% by mass or more and 10% by mass or less of a total mass of the toner particles.

(((3))) The electrostatic image developing toner according to (((2))),
wherein the content of the ultraviolet absorber is 0.1% by mass or more and 1.5% by mass or less of the total mass of the toner particles.

(((4))) The electrostatic image developing toner according to any one of (((1))) to (((3))),
wherein the ultraviolet absorber includes a triazine compound.

(((5))) The electrostatic image developing toner according to any one of (((1))) to (((4))),
wherein a total content of the radical scavenger and the peroxide decomposer is 0.05% by mass or more and 5% by mass or less of a total mass of the toner particles.

(((6))) The electrostatic image developing toner according to any one of (((1))) to (((5))),
wherein the radical scavenger includes a hindered amine compound.

(((7))) The electrostatic image developing toner according to any one of (((1))) to (((6))),
wherein the peroxide decomposer includes a phosphite compound.

(((8))) The electrostatic image developing toner according to any one of (((1))) to (((7))),
wherein the fluorescent colorant includes a rhodamine compound.

(((9))) An electrostatic image developer including the electrostatic image developing toner according to any one of (((1))) to (((8))).

(((10))) A toner cartridge detachably attachable to an image forming apparatus, the toner cartridge including:
the electrostatic image developing toner according to any one of (((1))) to (((8))).

(((11))) A process cartridge detachably attachable to an image forming apparatus, the process cartridge including:
a developing unit that includes the electrostatic image developer according to (((9))) and develops an electrostatic image formed on a surface of an image holding member with the electrostatic image developer to form a toner image.

(((12))) An image forming apparatus including:
an image holding member;
a charging unit that charges a surface of the image holding member;
an electrostatic image formation unit that forms an electrostatic image on the surface of the image holding member;
a developing unit that includes the electrostatic image developer according to (((9))) and develops the electrostatic image formed on the surface of the image holding member with the electrostatic image developer to form a toner image;
a transfer unit that transfers the toner image formed on the surface of the image holding member onto a surface of a recording medium; and
a fixing unit that fixes the toner image transferred on the surface of the recording medium.

(((13))) An image forming method including:
charging a surface of an image holding member;
forming an electrostatic image on the surface of the image holding member;
developing the electrostatic image formed on the surface of the image holding member with the electrostatic image developer according to (((9))) to form a toner image;
transferring the toner image formed on the surface of the image holding member onto a surface of a recording medium; and
fixing the toner image transferred on the surface of the recording medium.

What is claimed is:

1. A core-shell electrostatic image developing toner comprising:
toner particles including a binder resin and a fluorescent colorant,
the toner particles having a structure including a core and a shell layer,
the core including the fluorescent colorant,
the shell layer including an ultraviolet absorber and at least one selected from the group consisting of a radical scavenger and a peroxide decomposer.

2. The electrostatic image developing toner according to claim 1,
wherein a content of the ultraviolet absorber is 0.01% by mass or more and 10% by mass or less of a total mass of the toner particles.

3. The electrostatic image developing toner according to claim 2,
wherein the content of the ultraviolet absorber is 0.1% by mass or more and 1.5% by mass or less of the total mass of the toner particles.

4. The electrostatic image developing toner according to claim 1,
wherein the ultraviolet absorber includes a triazine compound.

5. The electrostatic image developing toner according to claim 1,
wherein a total content of the radical scavenger and the peroxide decomposer is 0.05% by mass or more and 5% by mass or less of a total mass of the toner particles.

6. The electrostatic image developing toner according to claim 1,
wherein a content of the radical scavenger is 0.05% by mass or more and 5% by mass or less of a total mass of the toner particles.

7. The electrostatic image developing toner according to claim 1,
wherein a content of the peroxide decomposer is 0.05% by mass or more and 5% by mass or less of a total mass of the toner particles.

8. The electrostatic image developing toner according to claim 1,
wherein the radical scavenger includes a hindered amine compound.

9. The electrostatic image developing toner according to claim 1,
wherein the peroxide decomposer includes a phosphite compound.

10. The electrostatic image developing toner according to claim 1,
wherein the shell layer includes the ultraviolet absorber, the radical scavenger, and the peroxide decomposer.

11. The electrostatic image developing toner according to claim 10,
wherein the radical scavenger includes a hindered amine compound, and
the peroxide decomposer includes a phosphite compound.

12. The electrostatic image developing toner according to claim 1,
wherein the fluorescent colorant includes a rhodamine compound.

13. An electrostatic image developer comprising the electrostatic image developing toner according to claim 1.

14. An electrostatic image developer comprising the electrostatic image developing toner according to claim 2.

15. An electrostatic image developer comprising the electrostatic image developing toner according to claim 3.

16. An electrostatic image developer comprising the electrostatic image developing toner according to claim 4.

17. A toner cartridge detachably attachable to an image forming apparatus, the toner cartridge comprising:
the electrostatic image developing toner according to claim 1.

18. A process cartridge detachably attachable to an image forming apparatus, the process cartridge comprising:
a developing unit that includes the electrostatic image developer according to claim 13 and develops an electrostatic image formed on a surface of an image holding member with the electrostatic image developer to form a toner image.

19. An image forming apparatus comprising:
an image holding member;
a charging unit that charges a surface of the image holding member;
an electrostatic image formation unit that forms an electrostatic image on the surface of the image holding member;
a developing unit that includes the electrostatic image developer according to claim 13 and develops the electrostatic image formed on the surface of the image holding member with the electrostatic image developer to form a toner image;
a transfer unit that transfers the toner image formed on the surface of the image holding member onto a surface of a recording medium; and
a fixing unit that fixes the toner image transferred on the surface of the recording medium.

20. An image forming method comprising:
charging a surface of an image holding member;
forming an electrostatic image on the surface of the image holding member;
developing the electrostatic image formed on the surface of the image holding member with the electrostatic image developer according to claim 13 to form a toner image;
transferring the toner image formed on the surface of the image holding member onto a surface of a recording medium; and
fixing the toner image transferred on the surface of the recording medium.
